(19) United States
(12) Patent Application Publication
(10) Pub. No.: US 2018/0300965 A1
(43) Pub. Date: Oct. 18, 2018

(54) VEHICLE COMMUNICATION DEVICE AND VEHICLE COMMUNICATION SYSTEM

(71) Applicant: HONDA MOTOR CO., LTD., Minato-ku, Tokyo (JP)

(72) Inventors: Takashi Mori, Wako-shi (JP); Motohisa Hirose, Wako-shi (JP); Hiroshi Furumi, Wako-shi (JP); Toshihiro Kojima, Wako-shi (JP); Kenya Sakurai, Wako-shi (JP); Masayuki Yamazaki, Wako-shi (JP)

(21) Appl. No.: 15/765,725

(22) PCT Filed: Sep. 28, 2016
(86) PCT No.: PCT/JP2016/078595

§ 371 Date: Apr. 4, 2018

(30) Foreign Application Priority Data
Oct. 22, 2015 (JP) 2015-207929

(51) Int. Cl. G07C 5/00; B60W 50/00; H04W 4/40; B60W 10/30

(52) U.S. Cl. CPC G07C 5/008; B60W 50/0098; B60W 2050/0064; H04W 4/40; B60W 10/30; G07C 5/004

(57) ABSTRACT

A vehicle communication device includes a vehicle-side communication unit mounted in a vehicle and configured to communicate with a portable terminal device, an operation detection unit configured to detect that a user performs a first operation on an operation target different from the portable terminal device, and a vehicle-side control unit configured to control an in-vehicle device mounted in the vehicle on the basis of input information received from the portable terminal device by the vehicle-side communication unit. The vehicle-side control unit controls the vehicle-side communication unit so that instruction information for causing the portable terminal device to display an input screen for remotely controlling the in-vehicle device serving as a target of a second operation assumed to be performed by the user after the first operation is transmitted to the portable terminal device if the first operation is detected by the operation detection unit.

### TECHNICAL FIELD

The present invention relates to a vehicle communication device and a vehicle communication system.

Priority is claimed on Japanese Patent Application No. 2015-207929, filed Oct. 22, 2015, the content of which is incorporated herein by reference.

### BACKGROUND ART

Conventionally, technology for remotely operating a device mounted in a vehicle by using a portable terminal is well-known.

In relation to this, a remote operation system including in-vehicle equipment control devices configured to control pieces of in-vehicle equipment mounted in a vehicle; mobile communication equipment configured to remotely control the pieces of in-vehicle equipment through the in-vehicle equipment control devices; and vehicle-side wireless communication equipment interposed between the in-vehicle equipment control devices and the mobile communication equipment and configured to process wireless communication, and including an application execution means configured to execute an application for implementing remote control performed by the mobile communication equipment; and an execution control means configured to implement communication between the mobile communication equipment and the vehicle-side wireless communication equipment when an application is activated, collate inherent information received through communication with inherent information registered in advance, permit execution of the application if the collated pieces of information are consistent with each other, and inhibit the execution of the application if the collated pieces of information are inconsistent with each other is well-known (for example, see Patent Literature 1).

### CITATION LIST

### Patent Literatures

### [Patent Literature 1]

Japanese Unexamined Patent Application, First Publication No. 2014-69598

### SUMMARY OF INVENTION

### Technical Problem

However, in a conventional technology, because it is necessary for a user to actively operate a portable terminal and display an input screen for operating an in-vehicle device on the portable terminal, an operation by the user may be complicated.

The present invention has been made in consideration of such circumstances, and an objective of the present invention is to provide a vehicle communication device and a vehicle communication system capable of reducing an operation burden on a user.

### Solution to Problem

(1) According to an aspect of the present invention, a vehicle communication device includes a vehicle-side communication unit mounted in a vehicle and configured to communicate with a portable terminal device; an operation detection unit configured to detect that a user performs a first operation on an operation target different from the portable terminal device; and a vehicle-side control unit configured to control an in-vehicle device mounted in the vehicle on the basis of input information received from the portable terminal device by the vehicle-side communication unit, wherein the vehicle-side control unit controls the vehicle-side communication unit so that instruction information for causing the portable terminal device to display an input screen for remotely controlling the in-vehicle device serving as a target of a second operation assumed to be performed by the user after the first operation is transmitted to the portable terminal device if the first operation is detected by the operation detection unit.

(2) In the aspect (1), the operation detection unit may detect that a door of the vehicle is locked by the user as the first operation, and the vehicle-side control unit may control the vehicle-side communication unit so that the instruction information for causing the portable terminal device to display the input screen for remotely controlling the in-vehicle device serving as the target of the second operation is transmitted to the portable terminal device when the user opens a lid for replenishing the vehicle with in-vehicle energy as the second operation if the operation detection unit detects that the door of the vehicle is locked.

(3) In the aspect (1), the operation detection unit may detect that the user opens a lid for replenishing the vehicle with in-vehicle energy as the first operation, and the vehicle-side control unit may control the vehicle-side communication unit so that the instruction information for causing the portable terminal device to display the input screen for remotely controlling the in-vehicle device serving as the target of the second operation is transmitted to the portable terminal device when the user replenishes the vehicle with the in-vehicle energy as the second operation if the operation detection unit detects that the lid is opened.

(4) In the aspect (2) or (3), the vehicle-side control unit may control the vehicle-side communication unit and cause instruction information for causing the portable terminal device to display an input screen based on vehicle state information, which indicates a state of the vehicle, to be transmitted to the portable terminal device if the operation detection unit detects the first operation after causing the vehicle state information to be transmitted to the portable terminal device.

(5) In the aspect (4), the vehicle-side control unit may control the vehicle-side communication unit and cause instruction information for causing the portable terminal device to display an input screen including one or both of pieces of information related to the in-vehicle energy and information indicating a continuously travelable distance of the vehicle to be transmitted to the portable terminal device if the operation detection unit detects the first operation after causing the vehicle state information including the information related to the in-vehicle energy and the information indicating the continuously travelable distance of the vehicle to be transmitted to the portable terminal device.

(6) In the aspect (5), the vehicle-side control unit may determine whether or not to cause the instruction information to be transmitted to the portable terminal device in accordance with an amount of the in-vehicle energy.

(7) According to an aspect of the present invention, a vehicle communication system includes the vehicle communication device according to any one of the aspects (1) to (6); and the portable terminal device configured to communicate with the vehicle communication device and display an input screen for receiving an input operation of the user in accordance with the instruction information transmitted by the vehicle communication device.

(8) In the aspect (7), the vehicle communication system may further include an energy supply unit configured to supply the vehicle with the in-vehicle energy via a supply cable; and a cable connection portion provided in the vehicle and to which the supply cable is connected, wherein the operation detection unit may further detect that the user performs the second operation, and wherein the vehicle-side control unit may control the vehicle-side communication unit so that instruction information for causing the portable terminal device to display an input screen for remotely controlling an in-vehicle device serving as a target of a third operation assumed to be performed by the user after the second operation is transmitted to the portable terminal device if the operation detection unit detects the second operation.

(9) In the aspect (8), the portable terminal device may display an input screen including one or both of pieces of information related to the in-vehicle energy and information indicating a continuously travelable distance of the vehicle.

(10) In the aspect (9), the portable terminal device may determine whether or not to display the input screen in accordance with an amount of the in-vehicle energy.

(11) In any one of the aspects (7) to (10), the vehicle communication system may further include a portable key of the vehicle configured to remotely control an air-conditioning device mounted in the vehicle, wherein the vehicle-side communication unit may communicate with the portable key and receives an instruction signal according to an operation performed on the portable key from the portable key, and wherein the vehicle-side control unit may control the vehicle-side communication unit so that instruction information for causing the portable terminal device to display an input screen for remotely controlling the air-conditioning device is transmitted to the portable terminal device if the vehicle-side communication unit receives the instruction signal.

(12) In the aspect (11), the vehicle-side control unit may control the vehicle-side communication unit so that instruction information for causing the input screen to display one or both of pieces of information indicating an operation state of the air-conditioning device and information indicating a temperature within the vehicle is transmitted to the portable terminal device.

### Advantageous Effects of Invention

According to the aspects (1) and (7), it is possible to reduce an operation burden on the user by controlling the in-vehicle device mounted in the vehicle on the basis of input information received from the portable terminal device by the vehicle-side communication unit and controlling the vehicle-side communication unit so that the instruction information for causing the portable terminal device to display the input screen for remotely controlling the in-vehicle device serving as the target of the second operation assumed to be performed by the user with respect to the vehicle after the first operation is transmitted to the portable terminal device if the first operation is detected by the operation detection unit.

According to the aspect (2), the vehicle-side control unit controls the vehicle-side communication unit so that the instruction information for displaying the input screen for remotely controlling the in-vehicle device serving as the target of the second operation is transmitted to the portable terminal when the user opens the lid for replenishing the vehicle with the in-vehicle energy as the second operation if the operation detection unit detects that the door of the vehicle is locked so that it is possible to present an input screen for receiving an operation of opening the lid without a complex operation for the user having to get off or out of the vehicle.

According to the aspects (3) and (8), the vehicle-side control unit controls the vehicle-side communication unit so that the instruction information for causing the portable terminal device to display the input screen for remotely controlling the in-vehicle device serving as the target of the second operation is transmitted to the portable terminal device when the user replenishes the vehicle with the in-vehicle energy as the second operation if the operation detection unit detects that the lid is opened so that it is possible to present an input screen for receiving an operation of replenishing the vehicle with energy without a complex operation for the user having to open the lid.

According to the aspects (4), (5), and (9), the user getting off or out of the vehicle can determine whether or not to replenish the vehicle with energy by causing a screen based on the vehicle state information indicating a state of the vehicle to be displayed on the portable terminal device.

According to the aspects (6) and (10), the vehicle communication device or the portable terminal device determines whether or not to replenish the vehicle with energy so that it is possible to minimize unnecessary display of various types of input screens and improve convenience for the user.

According to the aspects (11) and (12), the vehicle-side communication unit communicates with the portable key and receives the instruction signal according to the operation performed on the portable key from the portable key and the vehicle-side control unit controls the vehicle-side communication unit so that the instruction information for causing the portable terminal device to display the input screen for remotely controlling the air-conditioning device is transmitted to the portable terminal device if the vehicle-side communication unit receives the instruction signal, so that it is possible to present an input screen for receiving an operation on the air-conditioning device without a complex operation for the user.

### BRIEF DESCRIPTION OF DRAWINGS

FIG. 1 is a diagram illustrating an example of a configuration of a vehicle communication system according to a first embodiment.

FIG. 2 is a diagram illustrating an example of a scene in which the vehicle communication system according to the first embodiment is applied.

FIG. 3 is a sequence diagram illustrating an example of a flow of a process of the vehicle communication system according to the first embodiment.

FIG. 4 is a flowchart illustrating an example of a flow of a process of a vehicle communication device according to the first embodiment.

FIG. 5 is a flowchart illustrating another example of the flow of the process of the vehicle communication device according to the first embodiment.

FIG. 6 is a flowchart illustrating an example of a flow of a process of a portable terminal device according to the first embodiment.

FIG. 7 is a diagram illustrating an example of a charging preparation screen to be displayed on a touch panel.

FIG. 8 is a diagram illustrating an example of an input screen for executing charging.

FIG. 9 is a flowchart illustrating an example of a flow of a process of a vehicle communication device according to a second embodiment.

FIG. 10 is a diagram illustrating an example of a scene in which a vehicle communication system according to a third embodiment is applied.

FIG. 11 is a sequence diagram illustrating an example of a flow of a process of a vehicle communication system according to the third embodiment.

FIG. 12 is a flowchart illustrating an example of a flow of a process of a vehicle communication device according to the third embodiment.

FIG. 13 is a flowchart illustrating an example of a flow of a process of a portable terminal device according to the third embodiment.

FIG. 14 is a diagram illustrating another example of an input screen displayed on a touch panel.

### DESCRIPTION OF EMBODIMENTS

Embodiments of a vehicle communication device and a vehicle communication system according to the present invention will be described below with reference to the drawings.

### <First Embodiment>

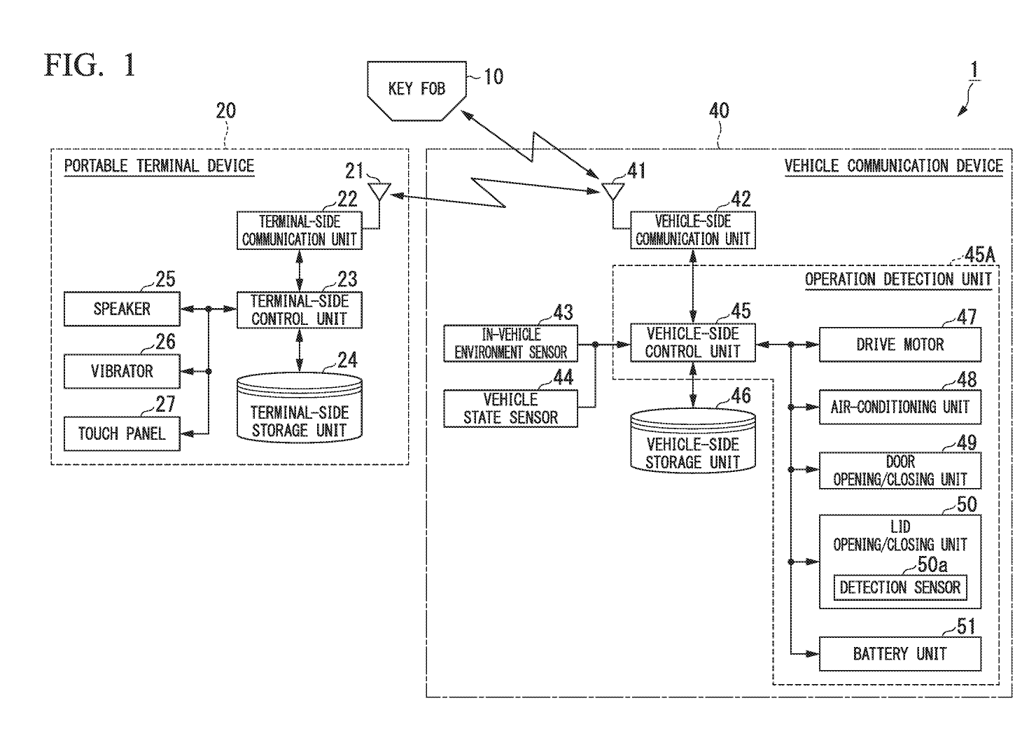

FIG. 1 is a diagram illustrating an example of a configuration of a vehicle communication system 1 according to a first embodiment. Although the vehicle communication system 1 according to the present embodiment may include, for example, a key fob 10, a portable terminal device 20, and a vehicle communication device 40, the present invention is not limited thereto. The vehicle communication system 1 is, for example, a system configured to remotely operate various types of devices mounted in a vehicle by using the key fob 10 and the portable terminal device 20.

For example, the key fob 10 (a portable key) is carried by a user and used in place of a mechanical key. The key fob 10 wirelessly communicates with the vehicle communication device 40 by using a frequency in a low frequency (LF) band or an ultra-high frequency (UHF) band, thereby performing locking or unlocking of a door of the vehicle, activation of a drive motor configured to generate a driving force when the vehicle travels, or the like. For example, the key fob 10 includes buttons (switches) for remotely operating locking/unlocking the door, activating/stopping the drive motor, turning on/off an air conditioner, locking/unlocking a lid, which will be described below, and the like. The key fob 10 transmits instruction signals corresponding to the buttons to the vehicle communication device 40 in response to operations (pressing) of these buttons.

The portable terminal device 20 wirelessly communicates with the vehicle communication device 40 by, for example, Bluetooth (registered trademark), Wi-Fi, or the like. Also, the portable terminal device 20 may wirelessly communicate with the vehicle communication device 40 by using a cellular network such as Long Term Evolution (LTE).

For example, the portable terminal device 20 is an electronic device capable of being carried by the user such as a portable phone, a smartphone, a tablet terminal, or a wearable terminal. Although the portable terminal device 20 may include an antenna 21, a terminal-side communication unit 22, a terminal-side control unit 23, a terminal-side storage unit 24, a speaker 25, a vibrator 26, and a touch panel 27, the present invention is not limited thereto. Under control of the terminal-side control unit 23, the terminal-side communication unit 22 wirelessly communicates with the vehicle communication device 40 via the antenna 21, transmits information to the vehicle communication device 40, or receives information from the vehicle communication device 40. A communication mode between the portable terminal device 20 and the vehicle communication device 40 may be similar to a communication mode between the key fob 10 and the vehicle communication device 40.

The terminal-side control unit 23 may be implemented by a processor such as a central processing unit (CPU) executing a program stored in the terminal-side storage unit 24. The program may be downloaded from an application server via a network such as a wireless local area network (LAN), a cellular network, a wide area network (WAN), or the Internet, or a program stored in a portable storage medium such an SD card may be installed in the portable terminal device 20.

Also, the terminal-side control unit 23 may be implemented by hardware such as large scale integration (LSI), an application specific integrated circuit (ASIC), a field-programmable gate array (FPGA), or the like. The terminal-side control unit 23 causes the terminal-side storage unit 24 to store information received by the terminal-side communication unit 22. Also, the terminal-side control unit 23 controls some or all of the speaker 25, the vibrator 26, and the touch panel 27 in accordance with the information received by the terminal-side communication unit 22.

The terminal-side storage unit 24 may be implemented by a nonvolatile storage medium such as a read-only memory (ROM), a flash memory, a hard disk drive (HDD), or an SD card, or a volatile storage medium such as a random access memory (RAM) or a register. In addition to storing a program to be executed by the processor, the terminal-side storage unit 24 stores information or the like received by the terminal-side communication unit 22.

The speaker 25 reproduces and outputs data of various types of speech or signal sounds previously stored in the terminal-side storage unit 24 in accordance with the control of the terminal-side control unit 23. The vibrator 26 drives a vibrator such as an eccentric motor in accordance with the control of the terminal-side control unit 23 to vibrate a housing of the portable terminal device 20.

The touch panel 27 includes, for example, a display device such as a liquid crystal panel and an input device such as a touch pad. The touch panel 27 displays the input screen on the basis of the control of the terminal-side control unit 23 and receives an input operation from the user. For example, the touch panel 27 receives a touch operation input to the input screen by a finger of the user and outputs a position (coordinates) of the received touch operation to the terminal-side control unit 23. The terminal-side control unit 23 detects that an operation such as tap, a swipe, or a flick is performed on the touch panel 27 on the basis of a change in the position of the touch operation input from the touch panel 27.

For example, the vehicle communication device 40 is installed in a vehicle including a secondary battery capable of being charged with power from an external device such as an electric vehicle and a plug-in hybrid vehicle as well as a gasoline-powered vehicle. Hereinafter, the vehicle in the present embodiment will be described as an electric vehicle. Although the vehicle communication device 40 may include an antenna 41, a vehicle-side communication unit 42, an in-vehicle environment sensor 43, a vehicle state sensor 44, a vehicle-side control unit 45, a vehicle-side storage unit 46, a drive motor 47, an air-conditioning unit 48, a door opening/closing unit 49, a lid opening/closing unit 50, and a battery unit 51, the present invention is not limited thereto. For example, if the vehicle is a vehicle having an internal combustion engine such as an engine like the above-described plug-in hybrid vehicle, the vehicle communication device 40 may include an engine or the like together with the drive motor 47. Hereinafter, a combination of the vehicle-side control unit 45, the air-conditioning unit 48, the door opening/closing unit 49, the lid opening/closing unit 50, and the battery unit 51 described above will be referred to as an operation detection unit 45A.

Under the control of the vehicle-side control unit 45, the vehicle-side communication unit 42 communicates with the portable terminal device 20 via the antenna 41, transmits information to the portable terminal device 20, and receives information from the portable terminal device 20.

For example, the in-vehicle environment sensor 43 detects a temperature and humidity in the vehicle. For example, the vehicle state sensor 44 detects a value of a current flowing through the battery unit 51 and a voltage value of the battery unit 51.

For example, the vehicle-side control unit 45 may be implemented by a processor such as a CPU executing a program stored in the vehicle-side storage unit 46. For example, the program may be downloaded from an application server via a network such as a wireless LAN, a cellular network, a WAN, or the like, or a program stored in a portable storage medium such as an SD card is installed in the vehicle communication device 40. Also, the vehicle-side control unit 45 may be implemented by hardware such as LSI, an ASIC, or an FPGA.

For example, the vehicle-side control unit 45 controls some or all of the drive motor 47, the air-conditioning unit 48, the door opening/closing unit 49, and the lid opening/closing unit 50 on the basis of information received by the vehicle-side communication unit 42. Also, the vehicle-side control unit 45 acquires detected values from the in-vehicle environment sensor 43 and the vehicle state sensor 44, outputs information based on the detected values to the vehicle-side communication unit 42, and causes the information to be transmitted to the portable terminal device 20.

For example, if the current value or the voltage value is acquired from the vehicle state sensor 44, the vehicle-side control unit 45 calculates a state of charge (SOC) of the battery unit 51 from the acquired value, and transmits information indicating the calculated SOC to the portable terminal device 20. The vehicle may include a dedicated control device (a battery control device) configured to manage the battery unit 51 as an entity for calculating the SOC. In this case, the vehicle-side control unit 45 acquires the SOC calculated by the battery control device via an in-vehicle communication network. Also, on the basis of a ratio between the calculated or acquired SOC and a preset maximum value (for example, a nominal spec value) of the SOC of the battery unit 51, the vehicle-side control unit 45 calculates a distance over which the vehicle can continuously travel (hereinafter referred to as a “continuously travelable distance”) if the vehicle is assumed to travel with an amount of electric power (an amount of charge) remaining in the battery unit 51. The vehicle-side control unit 45 transmits information indicating the calculated continuously travelable distance to the portable terminal device 20.

For example, the vehicle-side storage unit 46 may be implemented by a nonvolatile storage medium such as a ROM, a flash memory, an HDD, or an SD card, and a volatile storage medium such as a RAM or a register. In addition to storing the program executed by the processor, the vehicle-side storage unit 46 stores information or the like received by the vehicle-side communication unit 42.

The drive motor 47 is driven by electric power supplied by the battery unit 51 and generates a driving force required for traveling.

The air-conditioning unit 48 starts controlling an air-conditioning environment inside the vehicle, for example, if the vehicle-side communication unit 42 receives an air conditioning ON/OFF instruction signal transmitted by the key fob 10. Also, the air-conditioning unit 48 may start controlling the air-conditioning environment in the vehicle in accordance with an operation of an operation button provided on a dashboard or the like in the vehicle by the user.

The door opening/closing unit 49 locks the door provided in the vehicle (sets the door to a locked state) or unlocks the door (sets the door to an unlocked state), for example, if the vehicle-side communication unit 42 receives a door lock/unlock instruction signal transmitted by the key fob 10. Also, if a touch sensor is mounted in the door knob, the door opening/closing unit 49 may lock or unlock the door provided on the vehicle when the touch sensor detects that a finger of the user touches the door knob in a state in which communication with the key fob 10 is established. For example, the door opening/closing unit 49 locks the door when the door knob is touched in the unlocked state, and unlocks the door when the door knob is touched in the locked state.

For example, the lid opening/closing unit 50 locks or unlocks a lid provided to cover a connection portion configured to connect a charging cable connected to a charger used for charging the battery unit 51 and a power supply circuit for charging the battery unit 51 on the basis of an instruction signal from the portable terminal device 20 or the key fob 10. For example, the connection portion is provided in a form in which it is embedded in a vehicle body, and the lid is provided to prevent the connection portion from being operated from the outside of the vehicle body. For example, this lid corresponds to a fuel lid covering a fuel supply port of a fuel such as gasoline.

Normally, the lid opening/closing unit 50 locks the lid during normal operation and unlocks the lid during an operation such as charging, thereby opening the lid and exposing the connection portion to the outside of the vehicle body. For example, a detection sensor 50a configured to detect that the charging cable is connected is provided in the connection portion. The detection sensor 50a outputs a predetermined detection signal to the vehicle-side control unit 45 when the charging cable is connected to the connection portion.

For example, the battery unit 51 is implemented by a secondary battery such as a lithium ion battery or a lead storage battery. The secondary battery stores electric power supplied from an external device such as a charger, electric power (regenerative electric power) generated through the vehicle traveling, or the like, and supplies the stored electric power to each device such as the drive motor 47 or the air-conditioning unit 48. Also, the battery unit 51 may include a dedicated secondary battery configured to supply electric power to the drive motor 47 and a secondary battery configured to supply electric power to another in-vehicle device such as the air-conditioning unit 48. Also, the battery unit 51 may include a switch configured to make an electrical disconnection or connection in a circuit network until electric power (electric current) supplied from the charging cable connected to the connection portion reaches the secondary battery. For example, under the control of the vehicle-side control unit 45, the battery unit 51 switches this switch to apply the electric power (electric current) to the circuit network.

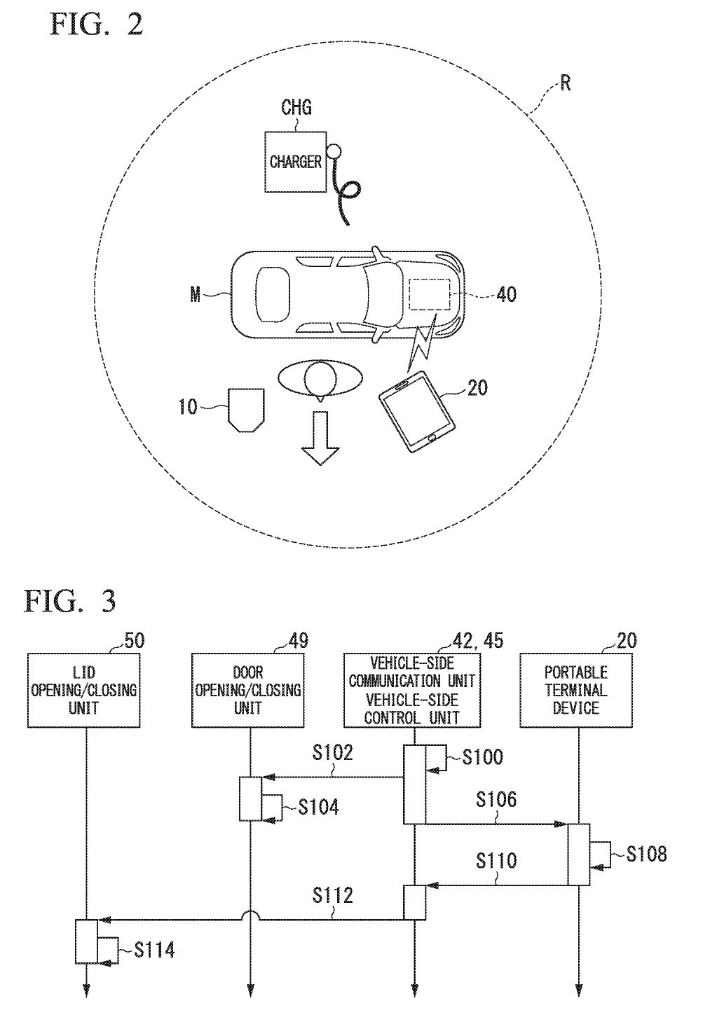

FIG. 2 is a diagram illustrating an example of a scene in which the vehicle communication system 1 according to the first embodiment is applied. The illustrated scene is a scene in which a user gets off or out of a vehicle M and intends to charge the battery unit 51 of the vehicle M by using a charger CHG. In FIG. 2, a reference symbol R indicates a region where the portable terminal device 20 and the vehicle communication device 40 can perform wireless communication (hereinafter referred to as a communication zone). The charger CHG is an example of an energy supply unit.

Hereinafter, a flow of a process performed by the vehicle communication system 1 in the scene illustrated in FIG. 2 will be described. FIG. 3 is a sequence diagram illustrating an example of a flow of a process of the vehicle communication system 1 according to the first embodiment. First, if a user operates a door lock button of the key fob 10, the vehicle-side communication unit 42 receives a door lock instruction signal from the key fob 10 (step S100). The vehicle-side control unit 45 transmits the door lock instruction signal received by the vehicle-side communication unit 42 to the door opening/closing unit 49 (step S102). When the door lock instruction signal is received, the door opening/closing unit 49 locks a door (step S104). Instead of (or in addition to) the processing of steps S100 and S102, the vehicle-side control unit 45 may control the door opening/closing unit 49 so that the door is locked on the basis of a door lock instruction signal from a touch sensor provided in the door when the user touches the touch sensor.

Next, the vehicle-side control unit 45 controls the vehicle-side communication unit 42 and causes instruction information indicating reception of the door lock instruction signal to be transmitted to the portable terminal device 20 (step S106). When this instruction information is received, the portable terminal device 20 causes the touch panel 27 to display an input screen on which the user can operate locking/unlocking of a lid on its own device (step S108). When an input for unlocking the lid on the input screen displayed on the touch panel 27 is received from the user, the portable terminal device 20 transmits instruction information according to the input to the vehicle-side communication unit 42 (step S110). Also, details of the input screen will be described below.

When the vehicle-side communication unit 42 receives instruction information indicating that the lid is unlocked from the portable terminal device 20, the vehicle-side control unit 45 relays the instruction information and transmits the instruction information to the lid opening/closing unit 50 (step S112). When the instruction information is received, the lid opening/closing unit 50 unlocks and opens the lid and exposes the connection portion to the outside of the vehicle body (step S114). Thereby, the user can charge the battery unit 51 of the vehicle M by connecting the charging cable to a joint portion by using the charger CHG.

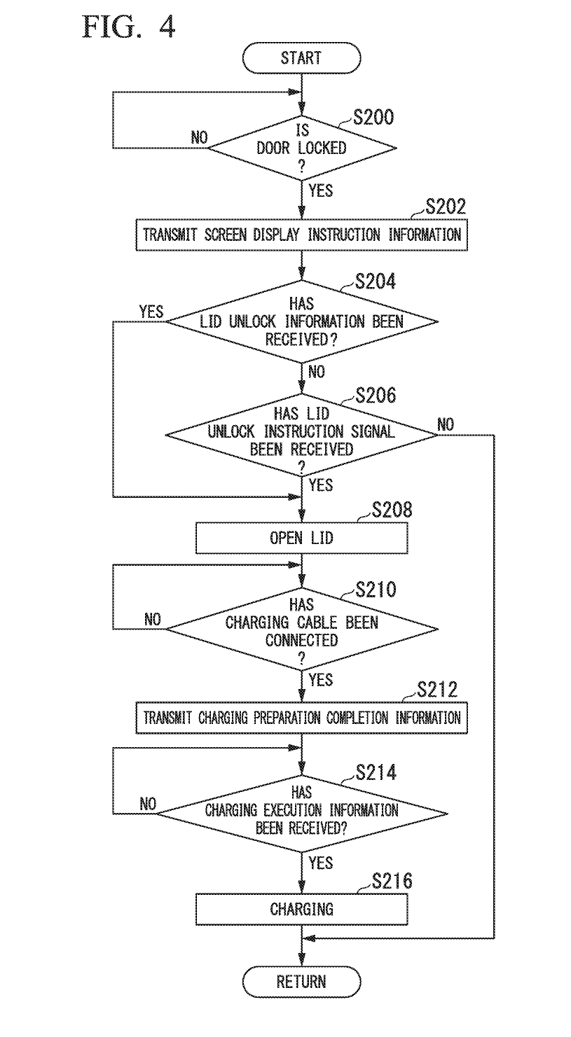

FIG. 4 is a flowchart illustrating an example of a flow of a process of the vehicle communication device 40 according to the first embodiment. For example, the process of this flowchart is iterated in a predetermined period.

First, the vehicle-side control unit 45 determines whether or not a door lock instruction signal has been received by the vehicle-side communication unit 42 (step S200). When the door lock instruction signal is received, the vehicle-side control unit 45 controls the door opening/closing unit 49 and causes a door of a vehicle to be locked.

Next, in response to the reception of the door lock instruction signal, the vehicle-side control unit 45 causes information for causing the touch panel 27 to display an input screen for allowing a user to operate locking/unlocking of a lid from the portable terminal device 20 (hereinafter referred to as “screen display instruction information”) to be transmitted to the portable terminal device 20 by controlling the vehicle-side communication unit 42 (step S202). Thereby, the portable terminal device 20 causes the touch panel 27 to display an input screen on which the locking/unlocking of the lid can be operated. For example, if the user inputs a lid unlock instruction to the input screen, the portable terminal device 20 transmits information indicating that the lid is unlocked (hereinafter referred to as lid unlock information) to the vehicle communication device 40. Details of a process of the portable terminal device 20 side will be described below with reference to a flowchart.

Next, the vehicle-side control unit 45 determines whether or not the lid unlock information has been received from the portable terminal device 20 by the vehicle-side communication unit 42 (step S204). If the lid unlock information has not been received, the vehicle-side control unit 45 determines whether or not a lid unlock instruction signal has been received from the key fob 10 by the vehicle-side communication unit 42 (step S206).

For example, the user may try to unlock the lid by operating the key fob 10 without operating the portable terminal device 20. Thus, the vehicle communication device 40 can cope with an operation of any of the two devices by performing a double determination of the above-described steps S204 and S206.

If lid unlock information is received or if lid unlock instruction signal is received, the vehicle-side control unit 45 controls the lid opening/closing unit 50 and causes the lid to be unlocked and opened (step S208).

Next, the vehicle-side control unit 45 determines whether or not the charging cable has been connected to the connection portion in accordance with the presence or absence of reception of a detection signal of the detection sensor 50a (step S210). For example, the vehicle-side control unit 45 determines that the charging cable has been connected to the connection portion if the detection signal of the detection sensor 50a has been received, and the vehicle-side control unit 45 determines that the charging cable has not been connected to the connection portion if the detection signal of the detection sensor 50a has not been received.

When the charging cable is connected to the connection portion, the vehicle-side control unit 45 controls the vehicle-side communication unit 42 so that information indicating that preparation for charging the battery unit 51 is completed (hereinafter referred to as charging preparation completion information) is transmitted to the portable terminal device 20 (step S212).

For example, when the charging preparation completion information is received, the portable terminal device 20 displays an input screen for executing charging and transmits information (hereinafter referred to as charging execution information) input to the input screen to the vehicle communication device 40. When the charging execution information is received by the vehicle-side communication unit 42 (step S214: YES), the vehicle-side control unit 45 controls the circuit switch of the battery unit 51, causes electric power to be applied to the circuit network, and charges a secondary battery with the electric power supplied from the charging cable (step S216). Thereby, the process of this flowchart ends.

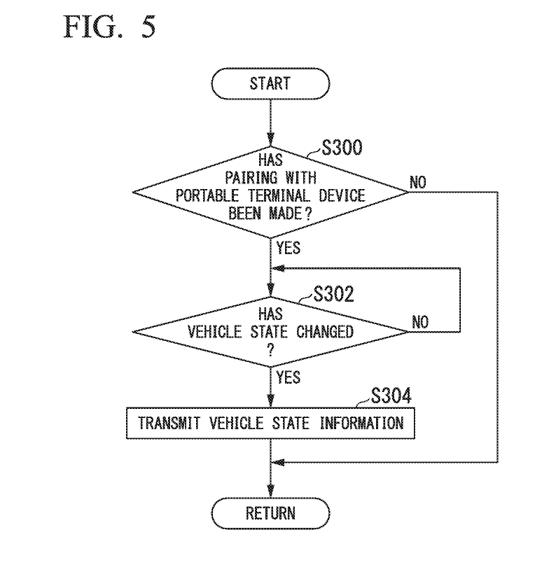

FIG. 5 is a flowchart illustrating another example of the flow of the process of the vehicle communication device 40 according to the first embodiment. For example, the processing of this flowchart is iterated across a predetermined period in a state in which communication with the key fob 10 is established. Also, the process of this flowchart is performed independently of the flowchart illustrated in FIG. 4 described above.

First, the vehicle-side control unit 45 determines whether or not pairing with the portable terminal device 20 has been made (step S300). For example, if an encryption key necessary for communication is previously exchanged between the vehicle communication device 40 and the portable terminal device 20, i.e., if the vehicle-side control unit 45 registers the portable terminal device 20 as a communication target device and the portable terminal device 20 registers the vehicle-side control unit 45 as a communication target device, the vehicle-side control unit 45 determines that the pairing with the portable terminal device 20 has been made.

If the pairing with the portable terminal device 20 has been made, the vehicle-side control unit 45 determines whether or not a vehicle state (for example, the

SOC of the battery unit 51, the continuously travelable distance, or the like) has changed (step S302). Specifically, the vehicle-side control unit 45 determines whether or not the vehicle state has changed by determining whether or not an amount of change in a value of the SOC, the continuously travelable distance, or the like of the battery unit 51 indicating the vehicle state exceeds a threshold value.

When the vehicle state changes, the vehicle-side control unit 45 controls the vehicle-side communication unit 42 and causes information including information indicating the SOC of the battery unit 51 and information indicating the continuously travelable distance (hereinafter referred to as “vehicle state information”) to be transmitted to the portable terminal device 20 (step S304). Even when there is no change in the vehicle state, the vehicle-side control unit 45 may transmit the vehicle state information to the portable terminal device 20, for example, in accordance with a predetermined period or a predetermined traveling distance. Also, the vehicle-side control unit 45 may control the vehicle-side communication unit 42 so that the above-described vehicle state information is transmitted to the portable terminal device 20 at a timing at which the traveling of the vehicle is completed. By iterating this process, the vehicle-side control unit 45 controls the vehicle-side communication unit 42 and causes the vehicle state information to be transmitted to the portable terminal device 20 every time the vehicle state changes.

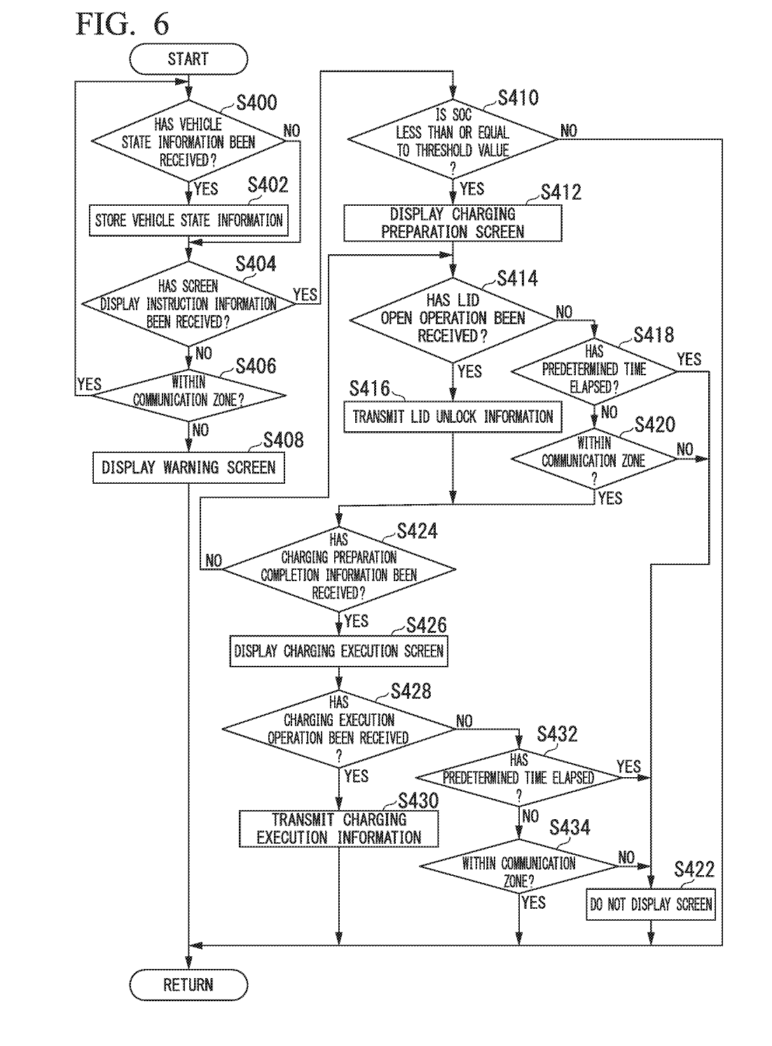

FIG. 6 is a flowchart illustrating an example of the flow of the process of the portable terminal device 20 according to the first embodiment. The process of this flowchart is performed, for example, in a state in which the portable terminal device 20 is paired with the vehicle communication device 40.

First, the terminal-side control unit 23 determines whether or not vehicle state information has been received by the terminal-side communication unit 22 (step S400). When the vehicle state information has been received, the terminal-side control unit 23 causes the terminal-side storage unit 24 to store the vehicle state information (step S402).

Next, the terminal-side control unit 23 determines whether or not screen display instruction information has been received by the terminal-side communication unit 22 (step S404). If the screen display instruction information has not been received, the terminal-side control unit 23 determines whether or not the portable terminal device 20 is within the communication zone R (step S406). If a position of the portable terminal device 20 is within the communication zone R, the terminal-side control unit 23 returns to the above-described processing of step S400 and iterates a process of causing the vehicle state information to be stored in the terminal-side storage unit 24 every time the vehicle state information is received. If the position of the portable terminal device 20 is not within the communication zone R, the terminal-side control unit 23 determines that a user holds the portable terminal device 20 and is away from the vehicle M without the vehicle M being locked and causes the touch panel 27 to display a screen for warning the user that the door is not locked (step S408).

On the other hand, if the screen display instruction information is received, the terminal-side control unit 23 determines whether or not an SOC of the battery unit 51 included in latest vehicle state information (of the latest storage date and time) stored in the terminal-side storage unit 24 in the above-described processing of step S402 is less than or equal to a threshold value (step S410). This threshold value is set to, for example, a value (for example, about 90%) at which it is determined that the SOC of the battery unit 51 is sufficient and the necessity of charging is low.

Thereby, because the portable terminal device 20 does not display the screen when the SOC of the battery unit 51 is sufficient, convenience for the user can be improved.

If the SOC of the battery unit 51 is less than or equal to the threshold value, the terminal-side control unit 23 causes the touch panel 27 to display a screen including information indicating the SOC of the battery unit 51 and information indicating the continuously travelable distance included in the vehicle state information and a touch region for allowing the user to select whether or not to open the lid (hereinafter referred to as a “charging preparation screen”) (step S412). Also, the terminal-side control unit 23 may cause the touch panel 27 to display a charging preparation screen including a touch region for selecting a charging start clock time. Thereby, the user can confirm the SOC of the battery unit 51 even after the vehicle is stopped and locked.

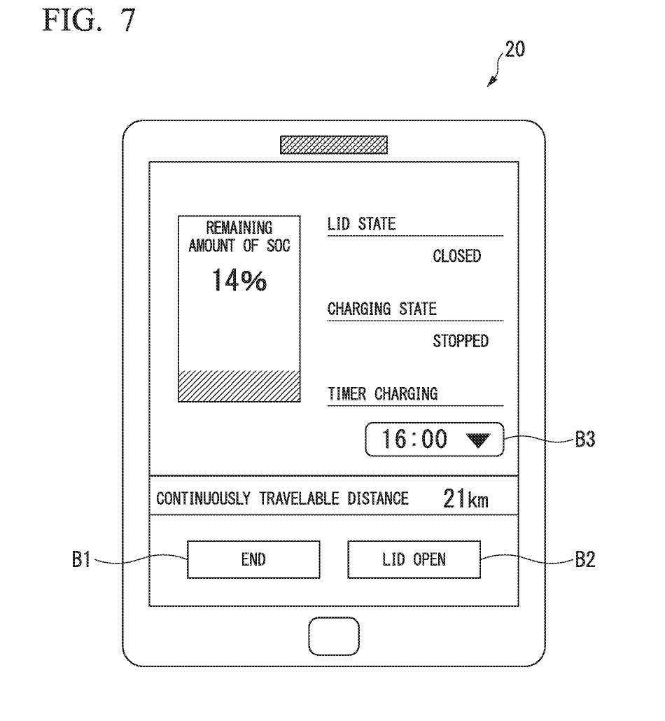

FIG. 7 is a diagram illustrating an example of a charging preparation screen to be displayed on the touch panel 27. As illustrated, on the charging preparation screen, for example, a remaining amount of the SOC of the battery unit 51, a lid state indicating whether or not the lid is opened, a state of charge indicating whether or not the battery is currently charged, a continuously travelable distance, a touch region B1 for selecting non-opening of the lid, a touch region B2 for selecting opening of the lid, and a touch region B3 for selecting a charging start clock time are displayed. For example, when the user performs a touch operation in the touch region B3, the user can input any time. Such a charging preparation screen is displayed on the touch panel 27 so that the user can ascertain a currently remaining amount of the SOC and a continuously travelable distance of the battery unit 51 and determine whether or not to open the lid for performing charging on the basis of the remaining amount of the SOC and the continuously travelable distance.

Here, the description refers back to FIG. 6. The terminal-side control unit 23 determines whether or not the touch region B2 for selecting opening of the lid on the charging preparation screen displayed on the touch panel 27 has been subjected to a touch operation (step S414) and controls the terminal-side communication unit 22 so that lid unlock information is transmitted to the vehicle communication device 40 if the touch region B2 has been subjected to the touch operation (step S416). If the touch region B3 has been subjected to the touch operation and the charging start clock time has been set, the terminal-side control unit 23 transmits information indicating the charging start clock time to the vehicle communication device 40 together with the lid unlock information. Thereby, the vehicle communication device 40 starts charging at a clock time specified as the charging start clock time.

On the other hand, in a state in which the charging preparation screen is displayed on the touch panel 27, the terminal-side control unit 23 determines whether or not a predetermined time has elapsed if the touch region B1 or the touch region B2 has not been subjected to the touch operation (step S418). The setting of the predetermined time can be changed, for example, by the user operating the portable terminal device 20. If the predetermined time has not elapsed, the terminal-side control unit 23 determines whether or not a position of the portable terminal device 20 is within the communication zone R (step S420). If the predetermined time has elapsed or if the position of the portable terminal device 20 is not within the communication zone R, the terminal-side control unit 23 prevents the charging preparation screen displayed on the touch panel 27 from being displayed (step S422). The process of the flowchart ends. Thereby, for example, if the user moves away from the communication zone R without operating the touch panel 27 on which the charging preparation screen is displayed, the portable terminal device 20 does not automatically display the charging preparation screen. As a result, if the user does not charge the vehicle, the user does not need to cancel the sequential display of the charging preparation screen.

On the other hand, if the position of the portable terminal device 20 is within the communication zone R or if the lid unlock information has been transmitted to the vehicle communication device 40, the terminal-side control unit 23 determines whether or not the terminal-side communication unit 22 has received charging preparation completion information (step S424). If the charging preparation completion information has not been received, the terminal-side control unit 23 returns to the above-described processing of step S414.

On the other hand, if the charging preparation completion information has been received, the terminal-side control unit 23 causes the touch panel 27 to display an input screen for executing charging (step S426).

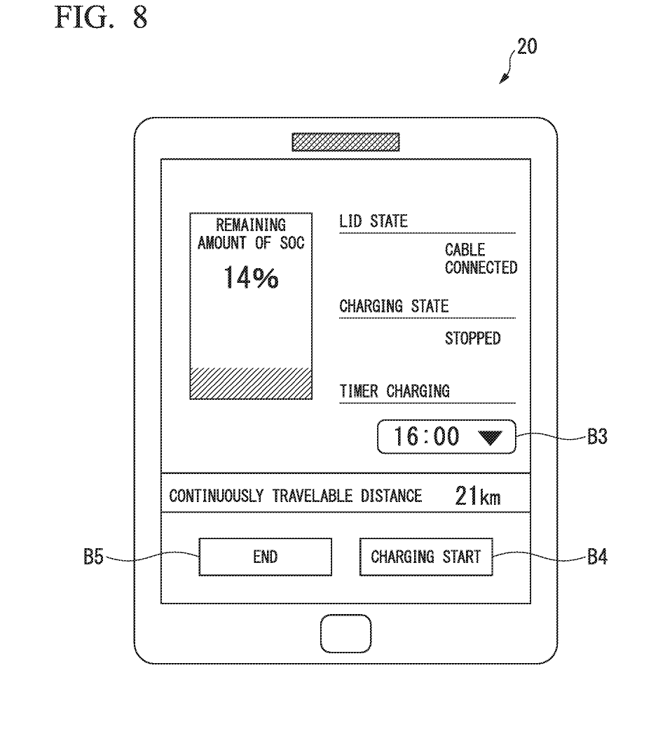

FIG. 8 is a diagram illustrating an example of an input screen for executing charging. As illustrated, on the input screen, for example, the remaining amount of the SOC of the battery unit 51, the lid state, the charging state, the continuously travelable distance, and the touch region B3 are displayed as in the charging preparation screen, and a touch region B4 for selecting execution of charging and a touch region B5 for selecting cancellation of charging are further displayed.

The terminal-side control unit 23 determines whether or not the touch region B4 for selecting execution of the charging on the input screen displayed on the touch panel 27 has been subjected to a touch operation (step S428) and controls the terminal-side communication unit 22 so that charging execution information is transmitted to the vehicle communication device 40 if the touch region B4 has been subjected to the touch operation (step S430).

On the other hand, the terminal-side control unit 23 determines whether or not a predetermined time has elapsed if the touch region B4 or the touch region B5 has not been subjected to the touch operation in a state in which the input screen for executing charging is displayed on the touch panel 27 (step S432). The predetermined time in step S432 and the predetermined time in step S418 described above may be the same or different. If the predetermined time has not elapsed, the terminal-side control unit 23 determines whether or not the position of the portable terminal device 20 is within the communication zone R (step S434). When the predetermined time has elapsed or when the position of the portable terminal device 20 is not within the communication zone R, the terminal-side control unit 23 performs the above-described processing of step S422. Thereby, for example, when the user moves away from the communication zone R without operating the touch panel 27 on which the input screen is displayed, the portable terminal device 20 does not automatically display the input screen. As a result, if the user does not charge the vehicle, the user does not need to cancel the display of the input screen.

According to the vehicle communication system 1 of the first embodiment described above, the vehicle-side communication unit 42 communicates with the portable terminal device 20, the operation detection unit 45A detects that the user performs a first operation on the vehicle and the vehicle-side control unit 45 controls the in-vehicle device mounted in the vehicle on the basis of input information received from the portable terminal device 20 and instruction information for causing the portable terminal device 20 to display an input screen for remotely controlling the in-vehicle device serving as a target of a second operation assumed to be performed by the user on the vehicle after the first operation is transmitted to the portable terminal device 20 if the first operation is detected so that it is possible to display an input screen for performing the charging operation on the portable terminal device 20, for example, when the user locks the door. As a result, the vehicle communication system 1 according to the first embodiment can reduce an operation burden on the user.

### <Second Embodiment>

A second embodiment will be described below. A vehicle communication system 1 according to the second embodiment is different from that of the first embodiment in that a vehicle communication device 40 performs a threshold value determination of an SOC of a battery unit 51. Hereinafter, differences from the first embodiment will be mainly described.

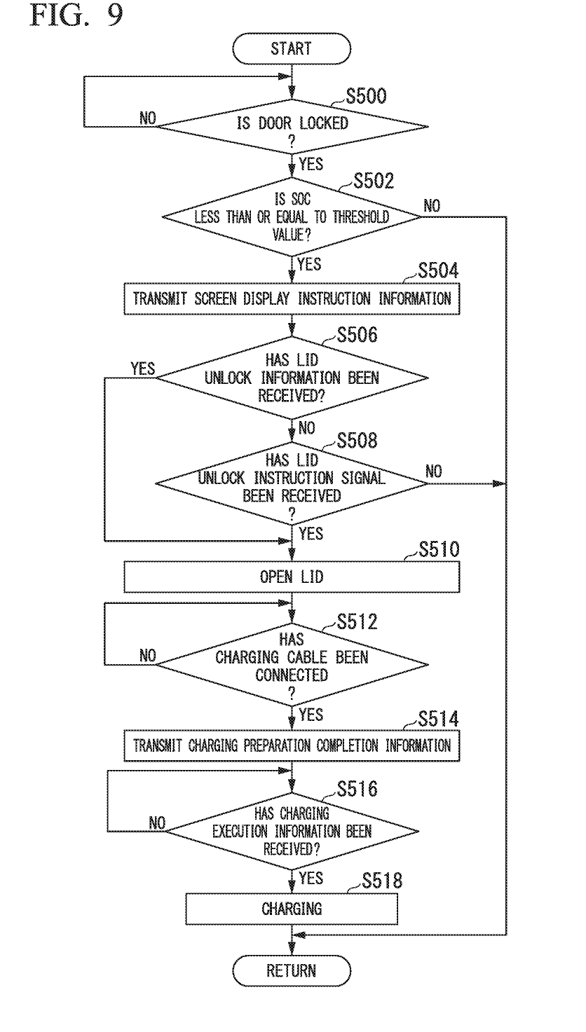

FIG. 9 is a flowchart illustrating an example of a flow of a process of the vehicle communication device 40 according to the second embodiment. The process of this flowchart is iterated, for example, in a predetermined period.

First, a vehicle-side control unit 45 determines whether or not a door lock instruction signal has been received by a vehicle-side communication unit 42 (step S500). When the door lock instruction signal has been received, the vehicle-side control unit 45 controls a door opening/closing unit 49 and causes a door of a vehicle to be locked.

Next, the vehicle-side control unit 45 determines whether or not the SOC of the battery unit 51 included in vehicle state information is less than or equal to a threshold value (step S502). When the SOC of the battery unit 51 exceeds the threshold value, the vehicle-side control unit 45 terminates the process of this flowchart. Thereby, if the SOC of the battery unit 51 is sufficient, a portable terminal device 20 does not display a charging preparation screen, and thus convenience for a user can be improved.

On the other hand, if the SOC of the battery unit 51 is less than or equal to the threshold value, the vehicle-side control unit 45 controls the vehicle-side communication unit 42 in response to the reception of the door lock instruction signal and causes screen display instruction information to be transmitted to the portable terminal device 20 (step S504).

Next, the vehicle-side control unit 45 determines whether or not lid unlock information has been received from the portable terminal device 20 by the vehicle-side communication unit 42 (step S506). If the lid unlock information has not been received, the vehicle-side control unit 45 determines whether or not a lid unlock instruction signal has been received from a key fob 10 by the vehicle-side communication unit 42 (step S508).

If the lid unlock information has been received or when the lid unlock instruction signal has been received, the vehicle-side control unit 45 controls a lid opening/closing unit 50 and causes a lid to be unlocked and opened (step S510).

Next, the vehicle-side control unit 45 determines whether or not a charging cable has been connected to a connection portion according to the presence or absence of a detection signal of a detection sensor 50a (step S512). If the charging cable has been connected to the connection portion, the vehicle-side control unit 45 controls the vehicle-side communication unit 42 so that charging preparation completion information indicating that preparation for charging the battery unit 51 is completed is transmitted to the portable terminal device 20 (step S514).

When charging execution information is received by the vehicle-side communication unit 42 (step S516: YES), the vehicle-side control unit 45 controls a circuit switch of the battery unit 51, causes electric power to be applied to the circuit network, and charges a secondary battery with the electric power supplied from the charging cable (step S518). Thereby, the process of this flowchart ends.

According to the above-described vehicle communication system 1 of the second embodiment, as in the first embodiment, for example, when the user locks the door, an input screen for performing a charging operation can be displayed on the portable terminal device 20. As a result, the vehicle communication system 1 according to the second embodiment can reduce an operation burden on the user.

### <Third Embodiment>

Hereinafter, a third embodiment will be described. A vehicle communication system 1 according to the third embodiment is different from those of the first and second embodiments in that a predetermined screen is displayed on a portable terminal device 20 when a user remotely operates air conditioning within a vehicle by operating a key fob 10. Hereinafter, related differences will be mainly described.

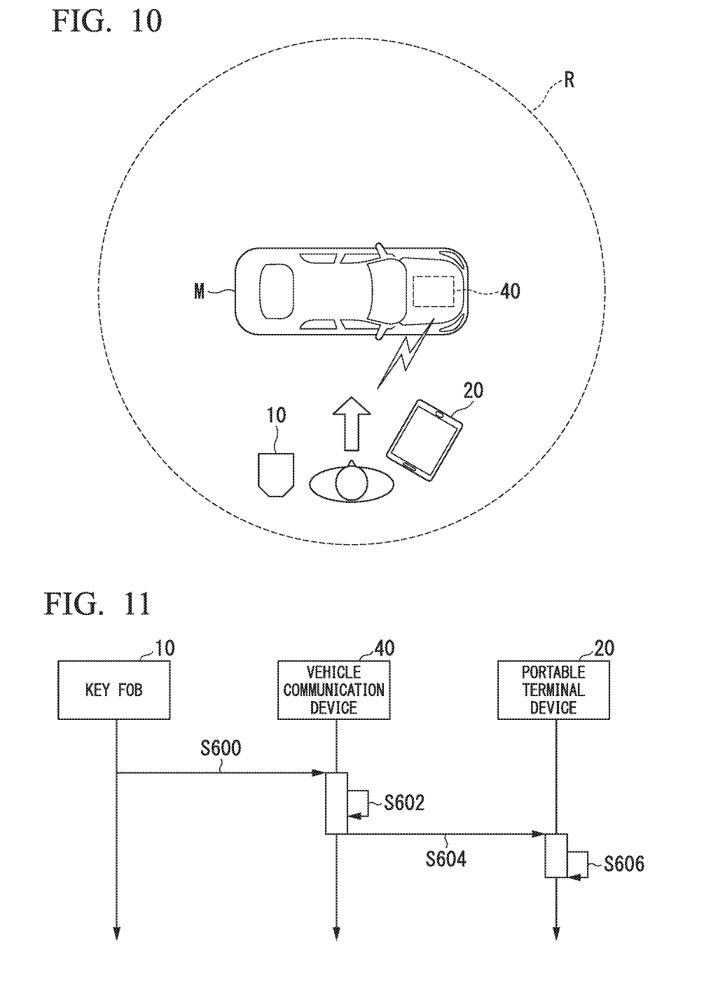

FIG. 10 is a diagram illustrating an example of a scene in which the vehicle communication system 1 according to the third embodiment is applied. For example, if a temperature inside a vehicle is not suitable for driving in a hot summer, a cold winter, or the like, it is assumed that a user operates the key fob 10 to control air conditioning inside the vehicle before getting in or on the vehicle. In this case, as in the illustrated scene, the user remotely operates the air conditioning in the vehicle by operating the key fob 10 before getting in or on a vehicle M.

Hereinafter, a flow of a process performed by the vehicle communication system 1 in the scene illustrated in FIG. 10 will be described. FIG. 11 is a sequence diagram illustrating an example of a flow of a process of the vehicle communication system 1 according to the third embodiment. First, the key fob 10 transmits an instruction signal for activating an air-conditioning unit 48 (hereinafter referred to as an air-conditioning activation signal) to a vehicle communication device 40 if a button for turning on the air conditioning is operated by an operation of the user (step S600). In response to this, the vehicle communication device 40 controls the air-conditioning unit 48 and causes control of an air-conditioning environment inside the vehicle to be started (step S602).

Also, the vehicle communication device 40 transmits information indicating a temperature, a humidity, and the like within the vehicle detected by an in-vehicle environment sensor 43 (hereinafter referred to as in-vehicle environment information) to the portable terminal device 20 (step S604). In response to this, the portable terminal device 20 causes a touch panel 27 to display a predetermined input screen (step S606).

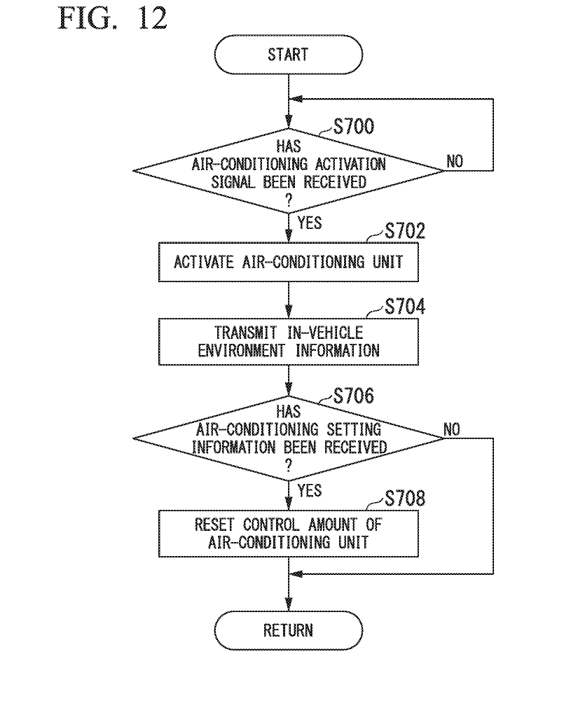

FIG. 12 is a flowchart illustrating an example of a flow of a process of the vehicle communication device 40 according to the third embodiment. The process of this flowchart is iterated, for example, in a predetermined period.

First, a vehicle-side control unit 45 determines whether or not an air-conditioning activation signal has been received by a vehicle-side communication unit 42 (step S700) and activates the air-conditioning unit 48 when the air-conditioning activation signal has been received (step S702). Next, the vehicle-side control unit 45 acquires detected values indicating a temperature, a humidity, and the like in the vehicle from the in-vehicle environment sensor 43, and controls the vehicle-side communication unit 42 so that in-vehicle environment information based on the acquired detected values is transmitted to the portable terminal device 20 (step S704).

The portable terminal device 20 having received this in-vehicle environment information displays an input screen on which air-conditioning ON/OFF, a target temperature, an air volume, and the like can be set. For example, when the user inputs the target temperature or the like to this input screen, the portable terminal device 20 transmits information for changing a setting of the air conditioning (hereinafter referred to as air-conditioning setting information) to the vehicle communication device 40. Details of the process on the portable terminal device 20 side will be described below with reference to a flowchart.

Next, the vehicle-side control unit 45 determines whether or not the above-described air-conditioning setting information has been received by the vehicle-side communication unit 42 (step S706). When the air-conditioning setting information has been received, the vehicle-side control unit 45 resets a control amount of the air-conditioning unit 48 (step S708). Thereby, the process of this flowchart ends.

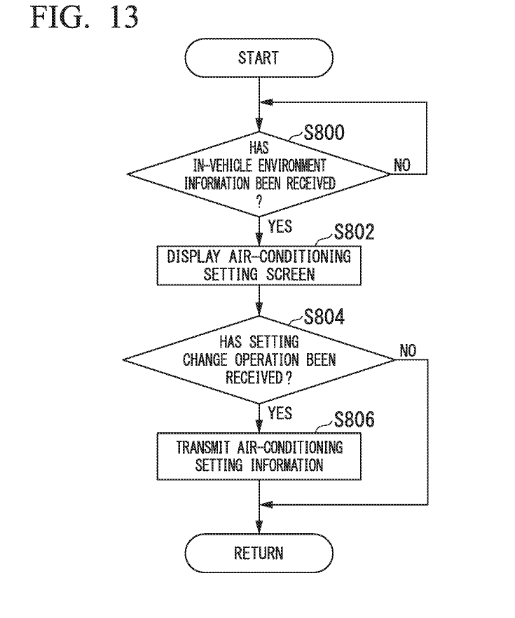

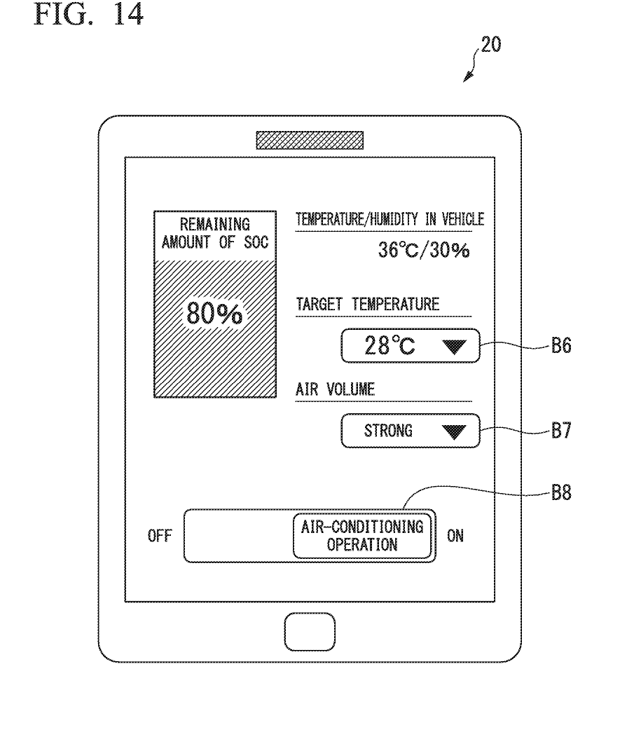

FIG. 13 is a flowchart illustrating an example of a flow of a process of the portable terminal device 20 according to the third embodiment. First, a terminal-side control unit 23 determines whether or not in-vehicle environment information has been received by a terminal-side communication unit 22 (step S800). If the in-vehicle environment information has been received, the terminal-side control unit 23 causes the touch panel 27 to display an input screen on which air-conditioning ON/OFF, a target temperature, an air volume, and the like can be set (step S802).

FIG. 14 is a diagram illustrating another example of the input screen displayed on the touch panel 27. As illustrated, on the input screen, for example, a remaining amount of an SOC of a battery unit 51, a temperature/humidity inside the vehicle, a touch region B6 for setting the target temperature, a touch region B7 for setting the air volume, and a touch region B8 for setting one or both of ON and OFF of an air-conditioning operation are displayed.

The touch region B8 is displayed, for example, in a state in which ON is set as default. As a result, the user who operates the key fob 10 to activate the air conditioning visually recognizes that the input screen illustrated in FIG. 14 is displayed on the portable terminal device 20, and thus it is possible to confirm that air conditioning within the vehicle is activated even if the user does not get into the vehicle.

Here, description returns to FIG. 13. On the input screen displayed on the touch panel 27, the terminal-side control unit 23 determines whether or not any one touch region has been subjected to a touch operation to change the setting of the air conditioning (step S804) and controls the terminal-side communication unit 22 so that air-conditioning setting information indicating that the setting has been changed is transmitted to the vehicle communication device 40 if the air-conditioning setting has been changed (step S806). Thereby, the user can set the target temperature or the like in the vehicle by operating the input screen on the portable terminal device 20.

According to the vehicle communication system 1 of the third embodiment described above, for example, when the user operates the key fob 10 to activate air conditioning, a setting screen of the air-conditioning unit 48 is displayed on the portable terminal device 20, and thus convenience for the user can be improved.

Other embodiments will be described below.

In the embodiment described above, when various types of screens are displayed on the touch panel 27, the portable terminal device 20 may output speech from the speaker 25 or may drive the vibrator 26 to vibrate.

Also, the vehicle communication device 40 may be configured to transmit screen display instruction information to the portable terminal device 20 if an SOC value of the battery unit 51 is changed by a fixed amount even when the door lock instruction signal is not received.

Although modes for carrying out the present invention have been described using embodiments, the present invention are not limited to the embodiments, and various modifications and substitutions can also be made without departing from the scope of the present invention.

### REFERENCE SIGNS LIST

1 Vehicle communication system

10 Key fob

20 Portable terminal device

21 Antenna

22 Terminal-side communication unit

23 Terminal-side control unit

24 Terminal-side storage unit

25 Speaker

26 Vibrator

27 Touch panel

40 Vehicle communication device

41 Antenna

42 Vehicle-side communication unit

43 In-vehicle environment sensor

44 Vehicle state sensor

45 Vehicle-side control unit

45A Operation detection unit

46 Vehicle-side storage unit

47 Drive motor

48 Air-conditioning unit

49 Door opening/closing unit

50 Lid opening/closing unit

50a Detection sensor

51 Battery unit

M Vehicle

What is claim is:

1. A vehicle communication device comprising:
a vehicle-side communication unit mounted in a vehicle and configured to communicate with a portable terminal device;
an operation detection unit configured to detect that a user performs a first operation on an operation target different from the portable terminal device; and
a vehicle-side control unit configured to control an in-vehicle device mounted in the vehicle on the basis of input information received from the portable terminal device by the vehicle-side communication unit,
wherein the vehicle-side control unit controls the vehicle-side communication unit so that instruction information for causing the portable terminal device to display an input screen for remotely controlling the in-vehicle device serving as a target of a second operation assumed to be performed by the user after the first operation is transmitted to the portable terminal device if the first operation is detected by the operation detection unit.

2. The vehicle communication device according to claim 1,
wherein the operation detection unit detects that a door of the vehicle is locked by the user as the first operation, and
wherein the vehicle-side control unit controls the vehicle-side communication unit so that the instruction information for causing the portable terminal device to display the input screen for remotely controlling the in-vehicle device serving as the target of the second operation is transmitted to the portable terminal device when the user opens a lid for replenishing the vehicle with in-vehicle energy as the second operation if the operation detection unit detects that the door of the vehicle is locked.

3. The vehicle communication device according to claim 1,
wherein the operation detection unit detects that the user opens a lid for replenishing the vehicle with in-vehicle energy as the first operation, and
wherein the vehicle-side control unit controls the vehicle-side communication unit so that the instruction information for causing the portable terminal device to display the input screen for remotely controlling the in-vehicle device serving as the target of the second operation is transmitted to the portable terminal device when the user replenishes the vehicle with the in-vehicle energy as the second operation if the operation detection unit detects that the lid is opened.

4. The vehicle communication device according to claim 2, wherein the vehicle-side control unit controls the vehicle-side communication unit and causes instruction information for causing the portable terminal device to display an input screen based on vehicle state information, which indicates a state of the vehicle, to be transmitted to the portable terminal device if the operation detection unit detects the first operation after causing the vehicle state information to be transmitted to the portable terminal device.

5. The vehicle communication device according to claim 4, wherein the vehicle-side control unit controls the vehicle-side communication unit and causes instruction information for causing the portable terminal device to display an input screen including one or both of pieces of information related to the in-vehicle energy and information indicating a continuously travelable distance of the vehicle to be transmitted to the portable terminal device if the operation detection unit detects the first operation after causing the vehicle state information including the information related to the in-vehicle energy and the information indicating the continuously travelable distance of the vehicle to be transmitted to the portable terminal device.

6. The vehicle communication device according to claim 5, wherein the vehicle-side control unit determines whether or not to cause the instruction information to be transmitted to the portable terminal device in accordance with an amount of the in-vehicle energy.

7. A vehicle communication system comprising:
the vehicle communication device according to claim 1; and
the portable terminal device configured to communicate with the vehicle communication device and display an input screen for receiving an input operation of the user in accordance with the instruction information transmitted by the vehicle communication device.

8. The vehicle communication system according to claim 7, further comprising:
an energy supply unit configured to supply the vehicle with the in-vehicle energy via a supply cable; and
a cable connection portion provided in the vehicle and to which the supply cable is connected,
wherein the operation detection unit further detects that the user performs the second operation, and
wherein the vehicle-side control unit controls the vehicle-side communication unit so that instruction information for causing the portable terminal device to display an input screen for remotely controlling an in-vehicle device serving as a target of a third operation assumed to be performed by the user after the second operation is transmitted to the portable terminal device if the operation detection unit detects the second operation.

9. The vehicle communication system according to claim 8, wherein the portable terminal device displays an input screen including one or both of pieces of information related to the in-vehicle energy and information indicating a continuously travelable distance of the vehicle.

10. The vehicle communication system according to claim 9, wherein the portable terminal device determines whether or not to display the input screen in accordance with an amount of the in-vehicle energy.

11. The vehicle communication system according to claim 7, further comprising:
a portable key of the vehicle configured to remotely control an air-conditioning device mounted in the vehicle,
wherein the vehicle-side communication unit communicates with the portable key and receives an instruction signal according to an operation performed on the portable key from the portable key, and
wherein the vehicle-side control unit controls the vehicle-side communication unit so that instruction information for causing the portable terminal device to display an input screen for remotely controlling the air-conditioning device is transmitted to the portable terminal device if the vehicle-side communication unit receives the instruction signal.

12. The vehicle communication system according to claim 11, wherein the vehicle-side control unit controls the vehicle-side communication unit so that instruction information for causing the input screen to display one or both of pieces of information indicating an operation state of the air-conditioning device and information indicating a temperature within the vehicle is transmitted to the portable terminal device.
